(19) United States
(12) Patent Application Publication
(10) Pub. No.: US 2025/0310109 A1
(43) Pub. Date: Oct. 2, 2025

(54) NON-TRANSITORY COMPUTER-READABLE RECORDING MEDIUM STORING COMPUTER PROGRAM FOR TERMINAL DEVICE, TERMINAL DEVICE, AND METHOD FOR CONTROLLING TERMINAL DEVICE

(71) Applicant: BROTHER KOGYO KABUSHIKI KAISHA, Nagoya (JP)

(72) Inventors: Hiroya NOJIRI, Nagoya (JP); Keisuke TAKEDA, Nagoya (JP)

(21) Appl. No.: 19/089,151

(22) Filed: Mar. 25, 2025

(30) Foreign Application Priority Data
Mar. 29, 2024 (JP) 2024-056376

(51) Int. Cl. H04L 9/32; H04L 9/08

(52) U.S. Cl. CPC H04L 9/3226; H04L 9/0866

(57) ABSTRACT

A terminal device may receive authentication-related information from a specific reading device. The terminal device may, in a case where the authentication-related information is received from the specific reading device and the authentication-related information includes first type of information, display, on a display of the terminal device, a first input screen for prompting a user to input a user identifier and a password. The terminal device may, in a case where the authentication-related information is received from the specific reading device and the authentication-related information includes second type of information, display, on the display, a second input screen different from the first input screen for prompting a user to input only a password instead of a user identifier and the password.

### REFERENCE TO RELATED APPLICATION

This application claims priority to Japanese Patent Application No. 2024-056376 filed on Mar. 29, 2024. The entire content of the priority application is incorporated herein by reference.

### BACKGROUND ART

An information processing system including an information processing device and an image forming device is known. When the image forming device receives a scan request, the image forming device displays an authentication information input screen for inputting authentication information including a user ID and a password.

### SUMMARY

A terminal device which displays an input screen for inputting information compatible with authentication for a reading device to read a document is known. Authentication methods may vary according to types of reading devices. An art configured to display an input screen that is compatible with a reading device is desired.

The present teachings provide an art configured to display an input screen that is compatible with a specific reading device in accordance with information included in authentication-related information.

The present teachings disclose a non-transitory computer-readable recording medium storing a computer program for a terminal device. The computer program, when executed by a processor of the terminal device, may cause the terminal device to: receive authentication-related information from a specific reading device, a reading device being for image reading from a document, the authentication-related information being related to authentication for the specific reading device to execute a process related to image reading from a document; in a case where the authentication-related information is received from the specific reading device and the authentication-related information includes first type of information, display, on a display of the terminal device, a first input screen for prompting a user to input a user identifier and a password; and in a case where the authentication-related information is received from the specific reading device and the authentication-related information includes second type of information different from the first type of information, display, on the display, a second input screen different from the first input screen for prompting a user to input only a password among a user identifier and the password.

According to the above configuration, the terminal device displays the first input screen for prompting the user to input a user identifier and a password in the case where the authentication-related information includes the first type of information, and in the case where the authentication-related information includes the second type of information, the terminal device displays the second input screen for prompting the user to input a password only. Accordingly, the terminal device can display an input screen that is compatible with the specific reading device in accordance with the information included in the authentication-related information.

A non-transitory computer-readable recording medium storing above-described computer program, a terminal device realized by the above-mentioned computer program and a method of controlling the above-described terminal device are also novel and useful. Also, a communication system comprising a terminal device and a specific reading device is novel and useful.

### BRIEF DESCRIPTION OF DRAWINGS

FIG. 1 illustrates a configuration of a communication system.

FIG. 2 illustrates an example of a security setting screen.

FIG. 3 illustrates an example of the security setting screen.

FIG. 4 illustrates a flowchart of an input screen display process executed by a terminal device.

FIG. 5 illustrates a sequence diagram of a specific case.

FIG. 6 illustrates an example of a home screen displayed on the terminal device in a second embodiment.

FIG. 7 illustrates an example of a second input screen according to a third modification.

FIG. 8 illustrates an example of a second input screen according to a fourth modification.

### DESCRIPTION

### First Embodiment

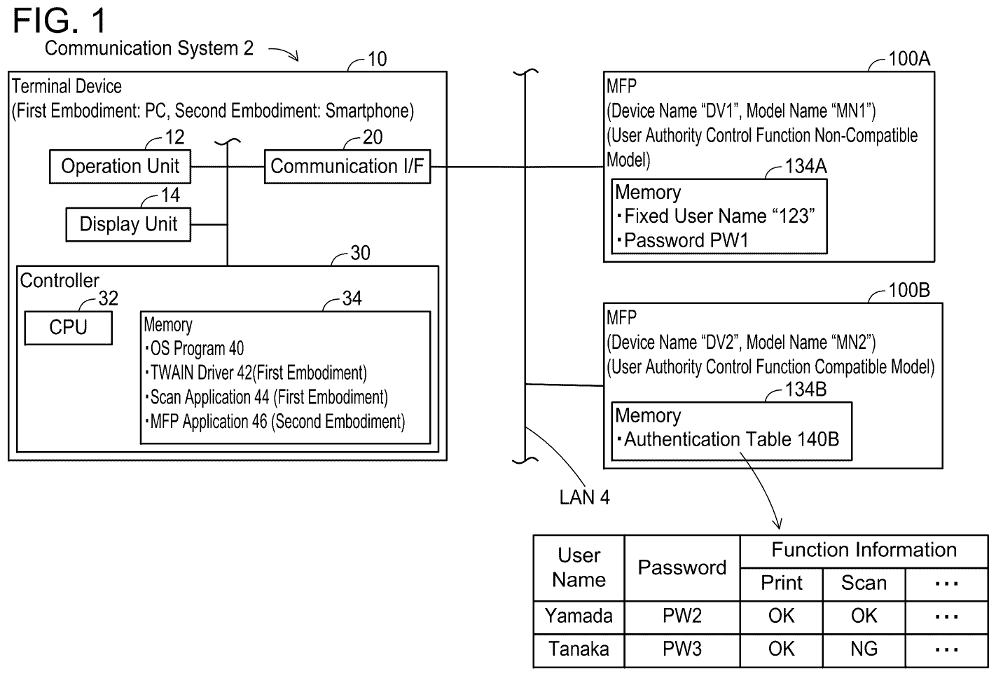

### (Configuration of Communication System 2; FIG. 1)

As illustrated in FIG. 1, a communication system 2 comprises a terminal device 10 and a plurality of MFPs 100A, 100B. The terminal device 10 and the MFPs 100A, 100B are connected to a Local Area Network (LAN) 4. The terminal device 10 and the MFPs 100A, 100B are configured to communicate with each other via the LAN 4.

### (Configuration of Terminal Device 10)

The terminal device 10 is a PC such as a desktop PC, a laptop PC, or a tablet PC. The terminal device 10 comprises an operation unit 12, a display unit 14, a communication interface 20, and a controller 30. Hereafter, an interface will be termed “I/F”.

The operation unit 12 is an I/F which enables a user to input various information to the terminal device 10. The operation unit 12 includes, for example, a touch panel for displaying software key(s) (operation area), hardware key(s), or both of them. The hardware key(s) include, for example, button(s) and/or switch(es). The display unit 14 is a display or a panel for displaying various information. The display is for example a liquid crystal display or an organic EL display. The panel may or may not be a touch panel. Also, the panel is for example a liquid crystal panel or an organic EL panel. The communication I/F 20 is connected to the LAN 4. The communication I/F 20 may be a wired I/F, or may be a wireless I/F.

The controller 30 comprises a CPU 32 and a memory 34. The memory 34 comprises a primary storage and an auxiliary storage. Although this is an example, the primary storage includes a RAM and cache memory. Although this is an example, the auxiliary storage may be a ROM, a flash memory, a Solid State Drive (SSD), a Hard Disk Drive (HDD), or a combination thereof. An Operating System (OS) program 40, a TWAIN driver 42, and a scan app 44 are stored in the auxiliary storage of the memory 34. Hereafter, the OS program 40 and the TWAIN driver 42 will be respectively termed “OS 40” and “driver 42”. The OS 40 controls basic operations of the terminal device 10. The OS 40 in the present embodiment is a program compatible with a PC. Although this is an example, the OS 40 is Windows (registered trademark). The driver 42 is a driver which causes an MFP to scan in cooperation with the scan app 44. Here, the driver 42 and the scan app 44 execute various processes by accessing respective hardware(s) such as the display unit 14, the memory 34, and/or the communication I/F 20 via the OS 40. Hereafter, a recitation about the driver 42 and the scan app 44 executing a process via the OS 40 may be omitted as needed.

(Configuration of MFPs 100A, 100B)

Each of the MFPs 100A, 100B is a peripheral device (i.e., a peripheral device for the terminal device 10 for example) configured to execute a print function of printing an image on a document and a scan function of reading an image from a document. The MFPs 100A, 100B are further configured to execute a webserver function. The webserver function is a function of sending webpage data representing a webpage to an external device in response to the external device accessing a webserver in the MFPs 100A, 100B. Each of the MFPs 100A, 100B comprises a print mechanism configured to execute the print function and a reading mechanism configured to execute the scan function. The print mechanism includes a print engine of inkjet scheme, electrophotographic scheme, or thermal scheme. The reading mechanism comprises a scan engine including an image sensor. The reading mechanism reads out an image from a document. Although this is an example, the image sensor is a Charge-Coupled Device (CCD) image sensor, a Contact Image Sensor (CIS).

The MFP 100B comprises a memory 134B. An authentication table 140B is stored in the memory 134B. In the authentication table 140B, for each of one or more users who use the MFP 100B, a user name, a password, and function information are stored in association with each other. The function information is information for specifying function(s) the user is permitted to use in regards to the print function, the scan function, etc. which the MFP 100B is configured to execute. “OK” indicates that the function corresponding to such information is permitted for use, and “NG” indicates that the function corresponding to such information is not permitted for use. Information in the authentication table 140B is set by an administrator of the MFP 100B.

The MFP 100B has a devie name “DV2” and a model name “MN2”. The device name is a name given by an administrator of the MFP. The model name is a name indicating a model of the MFP. The MFP 100B having the model name “MN2” is configured to execute authentication using a user name designated by a user and a password designated by the user. The MFP 100B supports a user authority control function which uses such authentication. That is, the model of the MFP 100B can be regarded as a user authority control function-compatible model. The user authority control function is a function that can set a user authority for every function on a security setting screen SC4 (see FIG. 3) to be described later.

The MFP 100A comprises a memory 134A. In the memory 134A, a fixed user name “123” and a password “PW1” are stored. The fixed user name is stored in the memory 134A since dispatch of the MFP 100A. That is, the fixed user name is not a name designated by a user, but is a user name designated by a vendor of the MFP 100A. The fixed user name “123” is set non-changeable. The MFP 100A has a device name “DV1” and a model name “MN1”. The MFP 100A having the model name “MN1” is configured to execute authentication using a fixed user name and a password designated by a user. In the MFP 100A, the authentication using a user name designated by a user and a password designated by the user is not executed. The MFP 100A does not support the user authority control function. That is, the model of the MFP 100A may be regarded as a user authority control function-non compatible model.

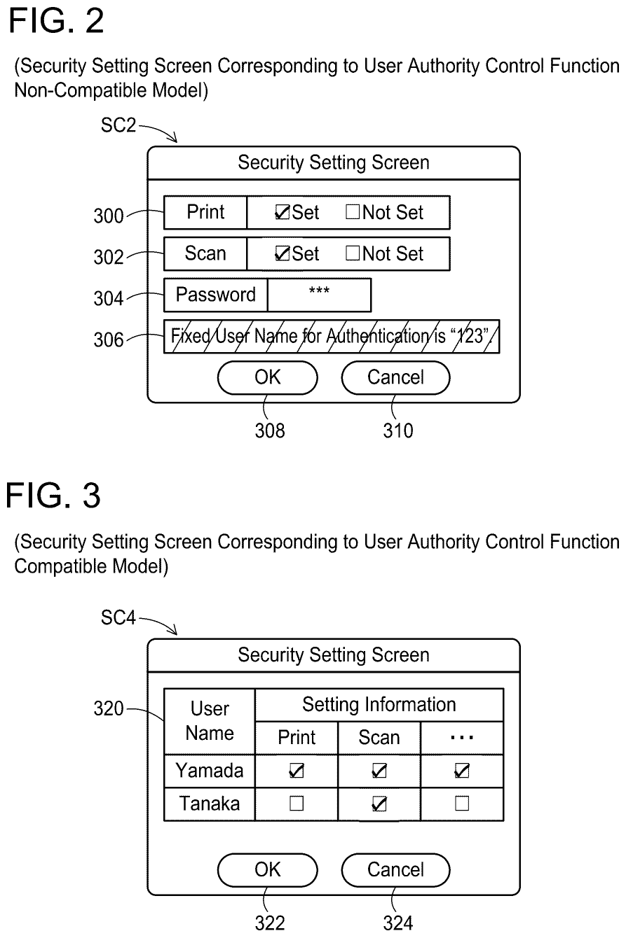

(Security Setting Screen Compatible Corresponding to User authority Control Function-Non-Compatible Model; FIG. 2)

With reference to FIG. 2, description will be given on a security setting screen SC2 displayed on a terminal device of an administrator in response to the administrator, being one of the users, using the terminal device of the administrator and accessing the MFP 100A. The security setting screen SC2 is displayed using the webserver function of the MFP 100A. The security setting screen SC2 includes a print setting area 300, a scan setting area 302, a password area 304, a message area 306, an OK button 308, and a Cancel button 310. The print setting area 300 is an area for setting whether authentication is necessary for the MFP 100A to execute the print function or not. The scan setting area 302 is an area for setting whether authentication is necessary for the MFP 100A to execute the scan function or not. The password area 304 is an area for setting a password used in the authentication. The message area 306 is an area for informing the user of the fixed user name “123” used in the authentication. The message area 306 is hatched in order to inform the user that the fixed user name “123” is non-changeable. In a modification, the message area 306 may be shown in a different form from those of the other areas, for example, may be shown in gray.

(Security Setting Screen Corresponding to User authority Control Function-Compatible Model; FIG. 3)

With reference to FIG. 3, description will be given on for a security setting screen SC4 displayed on the terminal device of the administrator in response to the administrator using the terminal device of the administrator and accessing the MFP 100B. The security setting screen SC4 is displayed using the webserver function of the MFP 100B. The security setting screen SC4 includes a setting area 320, an OK button 322, and a Cancel button 324. A user name and setting information are associated in the setting area 320. The setting information is an area for specifying a function which the user is permitted to use in regards to the print function, the scan function, for example. The use of such function is permitted in response to a checkbox corresponding to a respective function being checked. Although not illustrated, the administrator can display a screen for setting a user name and a password on the terminal device of the administrator in response to using the terminal device of the administrator and accessing the MFP 100B.

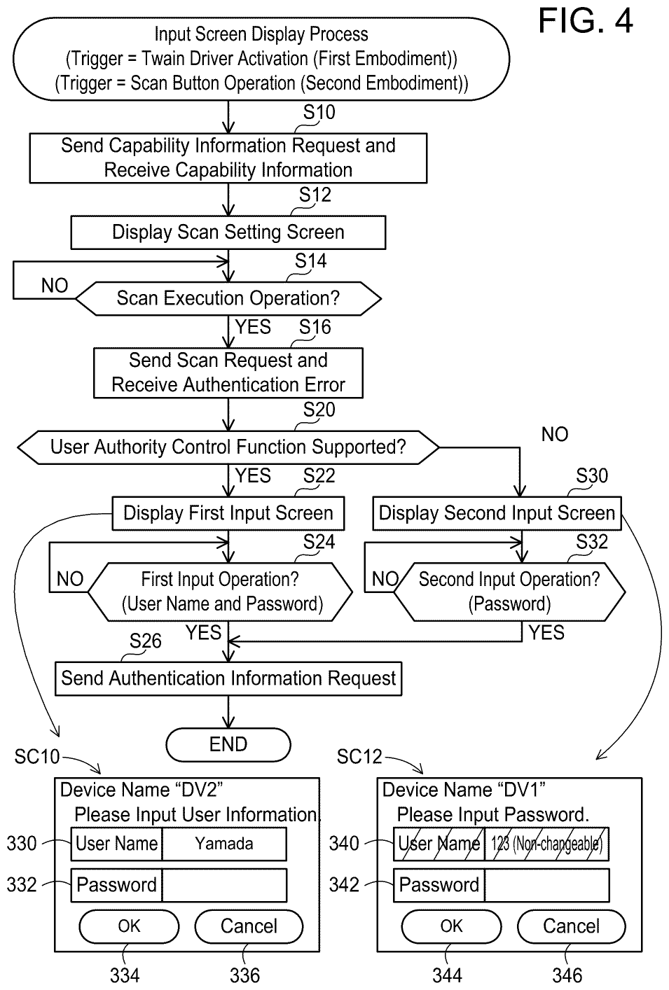

### (Input Screen Display Process; FIG. 4)

With reference to FIG. 4, an input screen display process executed by the driver 42 of the terminal device 10 will be described. The driver 42 executes processes of FIG. 4 in response to the driver 42 being activated. Specifically, a user of the terminal device 10 performs an operation for activating the scan app 44 on the terminal device 10. Due to this, the scan app 44 executes a search process for searching a device belonging to the LAN 4, and displays a search result screen on the display unit 14. The search result screen includes the device names “DV1”,“DV2”. Then, the user performs an operation of selecting one device name in the search result screen on the terminal device 10. Due to this, the scan app 44 executes a process for activating the driver 42, and supplies the device name selected by the user to the driver 42. Hereafter, an MFP having the device name selected by the user will be termed “target MFP”.

In S10, the driver 42 sends a capability information request to the target MFP, and receives capability information from the target MFP. The capability information request is a signal for requesting for a scan condition the MFP supports and support information to be sent. The scan condition may include, for example, a color condition, a paper size condition, a resolution condition. The support information is information for indicating whether the MFP supports the user authority control function or not. The support information “ON” indicates that the MFP supports the user authority control function, and the support information “OFF” indicates that the MFP does not support the user authority control function. Here, in a case where the MFP does not support the user authority control function, the capability information further includes the fixed user name.

In S12, the driver 42 displays a scan setting screen on the display unit 14 by using the scan condition in the received capability information.

In S14, the driver 42 monitors a scan executing operation being performed on the terminal device 10. In a case where the scan executing operation is performed on the terminal device 10, the driver 42 determines YES to S14 and proceeds to S16.

In S16, the driver 42 sends a scan request to the target MFP, and receives authentication error from the target MFP.

In S20, the driver 42 determines whether the target MFP supports the user authority control function or not by using the support information in the received capability information. The driver 42 determines that the target MFP supports the user authority control function (YES to S20) and proceeds to S22 in a case where the support information in the capability information is “ON”. Contrary to this, the driver 42 determines that the target MFP does not support the user authority control function (NO to S20), and proceeds to S30 in a case where the support information in the capability information is “OFF”.

In S22, the driver 42 displays a first input screen SC10 on the display unit 14. The first input screen SC10 includes a device name, a message for prompting the user to input user information, a first user name input area 330, a first password input area 332, an OK button 334, and a Cancel button 336. In the first user name input area 330, a user name that was used when logging in the terminal device 10 (e.g., “Yamada”) is inputted. That is, the driver 42 obtains the user name for logging in the OS 40 of the terminal device 10 from a predefined storage area of the terminal device 10, and automatically inputs such user name in the first user name input area 330. In a modification, the driver 42 may obtain the user name from the target MFP, and automatically input such user name in the first user name input area 330. Also, in another modification, the first user name input area 330 may be blank. The first password input area 332 is blank. The first user name input area 330 and the first password input area 332 are configured so that character(s) therein are changeable. Due to this, the first input screen SC10 is a screen for prompting the user to input a user name and a password.

In S24, the driver 42 monitors a first input operation being performed on the terminal device 10. The first input operation includes an operation of inputting a user name, an operating of inputting a password, and an operation of selecting the OK button 334. Here, in a case where the user name used when logging in the terminal device 10 and the user name used in the user authority control function match, the first input operation does not include the operation of inputting a user name. However, the user has already input that user name when the user logged in the terminal device 10. Due to this, it can be said that the user has already performed the operation of inputting that user name. In the case where the first input operation is performed on the terminal device 10, the driver 42 determines YES to S24 and proceeds to S26.

In S26, the driver 42 sends an authentication information request to the target MFP. The authentication information request is a signal which requests for authentication information generated by the MFP 100A to be sent. Thereafter, authentication using the user name and the password is executed at the target MFP. In a case where the authentication succeeds, the target MFP executes the scan function. Contrary to this, in a case where the authentication fails, the target MFP does not execute the scan function. When S26 ends, the driver 42 ends the processes of FIG. 4.

In S30, the driver 42 displays a second input screen SC12 on the display unit 14. The second input screen SC12 includes a device name, a message for prompting the user to input a password, a second user name input area 340, a second password input area 342, an OK button 344, and a Cancel button 346. In the second user name input area 340, a character string “123 (non-changeable)” is inputted. That is, in the second user name input area 340, the fixed user name “123” included in the capability information received in S10 is inputted. Also, the second user name input area 340 is configured so that character(s) therein are non-changeable. In the present embodiment, the second user name input area 340 is hatched in order to show that the second user name input area 340 is configured so that character(s) therein are non-changeable. In a modification, the second user name input area 340 may not be hatched, but the second user name input area 340 may be displayed in gray out. Contrary to this, the second password input area 342 is configured so that character(s) therein are changeable. Due to this, the second input screen SC12 is a screen for prompting the user to input only a password instead of a user name and a password. In a modification, the second user name input area 340 may be displayed in a different form from the other areas, for example, may be displayed in gray. As mentioned above, because the fixed user name “123” is inputted in the second user name input area 340, the user does not have to input the fixed user name “123”. Accordingly, user convenience can be improved. Also, because the second user name input area 340 is configured so that character(s) therein are non-changeable, the user can be suppressed from changing the fixed user name “123” by mistake. Further, since the fixed user name “123” is included in the capability information, the fixed user name “123” does not need to be stored in the memory 34 of the terminal device 10. Accordingly, storage capacity of the memory 34 can be effectively used.

In S32, the driver 42 monitors a second input operation being performed on the terminal device 10. The second input operation includes an operation of inputting a password and an operation of selecting the OK button 344. That is, the second input operation does not include the operation of inputting a user name. In a case where the second input operation is performed on the terminal device 10, the driver 42 determines YES to S32, and proceeds to S26. Thereafter, authentication using the fixed user name and a password is executed at the target MFP. In a case where the authentication succeeds, the target MFP executes the scan function. Contrary to this, in a case where the authentication fails, the target MFP does not execute the scan function.

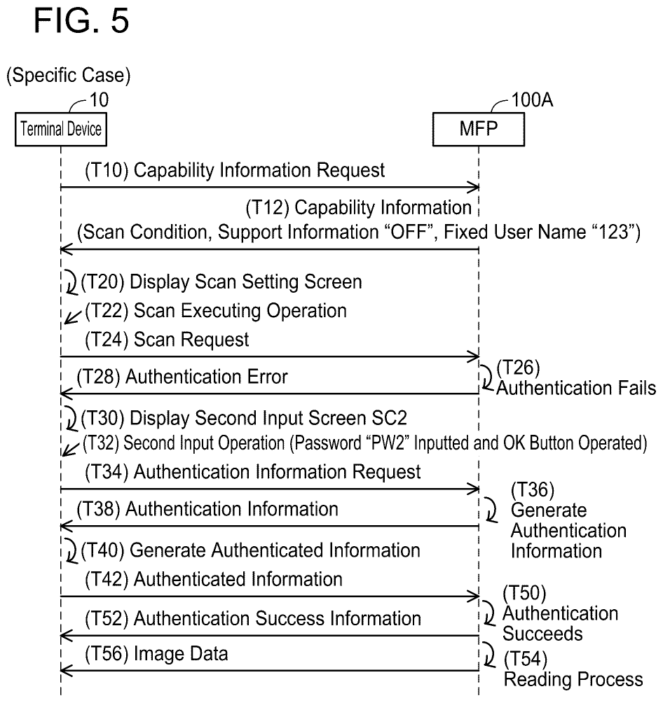

### (Specific Case; FIG. 5)

With reference to FIG. 5, a specific case executed by the communication system 2 of the present embodiment will be described.

In the present case, the process for activating the driver 42 is executed and the driver 42 of the terminal device 10 obtains the device name “DV1” from the scan app 44. In this case, in T10, the driver 42 sends the capability information request to the MFP 100A (S10 in FIG. 4). In a case where the driver 42 is activated, the user wishes to use the scan function of the MFP. Thus, the capability information can be received at a suitable timing.

When the MFP 100A receives the capability information request from the terminal device 10, the MFP 100A specifies the fixed user name “123” in the memory 134A, and in T12, the MFP 100A sends the capability information including the scan condition, the support information “OFF”, and the fixed user name “123” to the terminal device 10.

In T12, when the driver 42 receives the capability information from the MFP 100A (S10), in T20 the driver 42 displays a scan setting screen on the display unit 14 (S12). In T22, the user performs a scan executing operation on the terminal device 10 (YES to S14). Due to this, in T24, the driver 42 sends a scan request to the MFP 100A (S16).

When the MFP 100A receives the scan request from the terminal device 10, in T26 the MFP 100A determines that the authentication has failed because the request does not include the fixed user name “123” and the password “PW1”. In this case, in T28, the MFP 100A sends authentication error to the terminal device 10.

When in T28 the driver 42 receives the authentication error from the MFP 100A (S16), the driver 42 determines that the support information in the capability information received in T12 is “OFF” (NO to S20), and in T30 the driver 42 displays the second input screen SC12 on the display unit 14 (S30). In T32, the user performs the second input operation including an operation of inputting the password “PW1” and an operation of selecting the OK button 344 on the terminal device 10 (YES to S32). Due to this, in T34, the driver 42 sends the authentication information request to the MFP 100A (S26).

When in T34, the MFP 100A receives the authentication information request from the terminal device 10, in T36 the MFP 100A generates authentication information. Although this is an example, the authentication information is “nonce” and “realm”. In T38, the MFP 100A sends the generated authentication information to the terminal device 10.

When in T38 the driver 42 receives the authentication information from the MFP 100A, in T40 the driver 42 generates authenticated information by using the fixed user name “123”, the password “PW1”, and the authentication information. Although this is an example, the driver 42 uses a hash value obtained by hashing the fixed user name “123”, the password, and the authentication information with a hash function, as the authenticated information. In T42, the driver 42 sends the generated authenticated information to the MFP 100A.

When in T42 the MFP 100A receives the authenticated information from the terminal device 10, the MFP 100A generates a hash value by hashing the fixed user name “123”, the password “PW1”, and the authentication information with the same hash function as the hash function which the driver 42 used. In T50, because the generated hash value and the received hash value match, the MFP 100A determines that the authentication has succeeded. In this case, in T52 the MFP 100A sends an authentication success notification indicating that the authentication has succeeded to the terminal device 10, and in T54, the MFP 100A executes a reading process of reading a document placed on a document table of the MFP 100A. Next, in T56, the MFP 100A sends image data generated by the reading process to the terminal device 10. As such, the scan function of the MFP 100A is used.

### (Effects of Present Embodiment)

As mentioned above, in the case where the capability information includes the support information “ON” (YES to S20 in FIG. 4), the terminal device 10 displays the first input screen SC10 for prompting the user to input a user name and a password (S22), and in the case where the capability information includes the support information “OFF” (NO to S20), the terminal device 10 displays the second input screen SC12 for prompting the user to input a password only instead of a user name and a password (S30). Accordingly, the terminal device 10 can display an input screen compatible with either the MFP 100A or 100B according to the information included in the capability information.

### (Correspondence Relationships)

The driver 42 is an example for “computer program”. The MFPs 100A, 100B are examples of “specific reading device”. The capability information is an example for “authentication-related information”. The support information “ON” is an example for “first type of information”. The support information “OFF” is an example for “second type of information”. The user name is an example of “user identifier”. The reading process is an example for “process related to image reading from a document”. The capability information request is an example for “sending request”.

S12 in FIG. 4 is an example for a process executed by “receive authentication-related information”. S22 in FIG. 4 is an example for a process executed by “display, on a display of the terminal device, a first input screen”. S30 in FIG. 4 is an example of a process executed by “display, on the display, a second input screen”.

### Second Embodiment

A communication system 2 of a second embodiment will be described. As illustrated in FIG. 1, the terminal device 10 of the present embodiment is a smartphone. Due to this, the OS 140 is a program compatible with the smartphone. Although this is an example, the OS 140 is iOS (registered trademark), or Android (registered trademark). An MFP app 46, instead of the driver 42 and the scan app 44, is stored in the memory 34 of the terminal device 10. The MFP app 46 is a program for an MFP to execute the print function, the scan function. The MFP app 46 also has functions as a printer driver and a scanner driver. Here, the MFP app 46 executes respective processes by accessing each hardware such as the display unit 14, the memory 34, and the communication I/F 20 via the OS 40. Hereafter, a recitation about the MFP app 46 executing a process via the OS 40 may be omitted as needed.

In the present embodiment, the MFP app 46 executes the input screen display process of FIG. 4. Further, the processes of T10 to T56 in FIG. 5 are executed between the MFP app 46 and the MFP 100A.

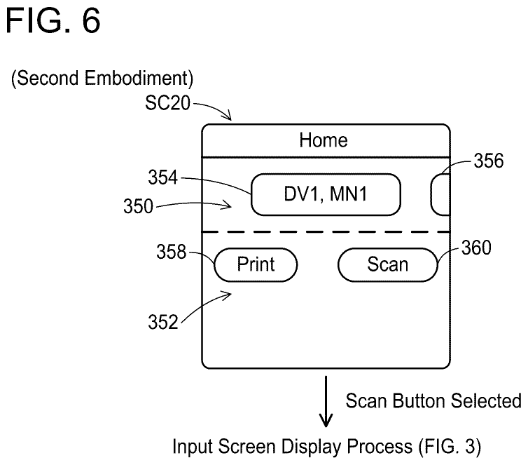

### (Home Screen; FIG. 6)

With reference to FIG. 6, a home screen SC20 displayed on the display unit 14 by the MFP app 46 will be described. The MFP app 46 displays the home screen SC20 on the display unit 14 in response to the MFP app 46 being activated. The home screen SC20 includes a device selection area 350 and a button area 352. At a center part of the device selection area 350, a device area indicating information related to an MFP selected as a destination of instruction information is displayed. The instruction information is a print instruction or a scan instruction. The user can change the MFP in selection by swiping in the device selection area 350. In FIG. 6, a device area 354 corresponding to the MFP 100A is displayed at the center part of the device selection area 350, and a left end part of a device area 356 corresponding to the MFP 100B is displayed at a right end part of the device selection area 350. In this state, the MFP 100A is selected as the destination of the instruction information. The button area 352 includes a Print button 358 and a Scan button 360. When the MFP app 46 receives an operation on the Scan button 360, the MFP app 46 determines the MFP in selection as the target MFP, and executes the input screen display process in FIG. 3. That is, the operation of selecting the Scan button 360 is an operation of selecting the target MFP. In a case where the Scan button 360 is selected under the state of FIG. 6, the MFP app 46 determines the MFP 100A as the target MFP, and executes the input screen display process in FIG. 4. When the Scan button 360 is activated by a user, the user wishes to use the scan function of the MFP. Accordingly, the capability information can be received at a suitable timing.

Here, in S22 in FIG. 4, the MFP app 46 displays the first input screen SC10 in which the first user name input area 330 is blank on the display unit 14.

### (Correspondence Relationships)

The MFP app 46 is an example for “computer program”.

(First Modification) The “reading device” may not be limited to an MFP, but may be a scanner having a scan function, for example.

(Second Modification) The capability information sent from the MFP 100A may not include the fixed user name “123” but may include the support information “OFF”. In the present modification, the fixed user name may be stored in the memory 34 of the terminal device 10. Also, in another modification, the capability information sent from the MFP 100A may not include the support information “OFF”, but may include the fixed user name “123”.

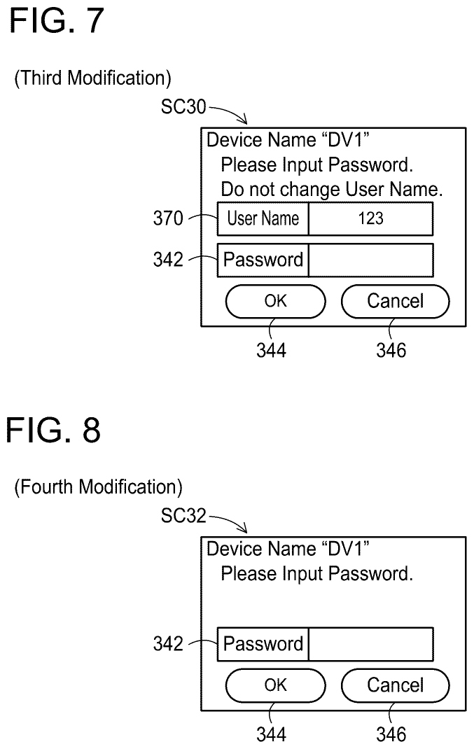

(Third Modification) In S30 in FIG. 4 according to the first embodiment, the driver 42 may display a second input screen SC30 in FIG. 7, instead of the second input screen SC12, on the display unit 14. The second input screen SC30 is the same as the second input screen SC12 in FIG. 4 except that the second input screen SC30 includes a message for requesting a user not to change a user name and a second user name input area 370 is configured so that character(s) therein are changeable. The message for requesting the user to not change the user name can prompt the user to input only a password instead of a user name and a password. Also, in S30 in FIG. 4 according to the second embodiment, the MFP app 46 may display the second input screen SC30 in FIG. 7, instead of the second input screen SC12, on the display unit 14.

(Fourth Modification) In S30 in FIG. 4 according to the first embodiment, the driver 42 may display a second input screen SC32 in FIG. 8, instead of the second input screen SC12, on the display unit 14. The second input screen SC32 is the same as the second input screen SC12 in FIG. 4 except that the second input screen SC32 does not include the second user name input area 340. Because the second input screen SC30 does not include the second user name input area 340, the user can be prompted to input only a password instead of a user name and a password. Further, in S30 in FIG. 4 according to the second embodiment, the MFP app 46 may display the second input screen SC32 in FIG. 8, instead of the second input screen SC12, on the display unit 14.

(Fifth Modification) Although in each of the above embodiments the processes of FIGS. 4, 5 are realized by software (e.g., program 42, 44, 46), at least one of these processes may be realized by hardware such as a logic circuitry.

(Sixth Modification) The “user identifier” may not be limited to a user name, but may be an email address of a user, user identification number, for example.

(Seventh Modification) The “process related to image reading from a document” may include a process for reading an image on a document, and outputting the read image to external.

What is claimed is:

1. A non-transitory computer-readable recording medium storing a computer program for a terminal device,
wherein the computer program, when executed by a processor of the terminal device, cause the terminal device to:
receive authentication-related information from a specific reading device, a reading device being for image reading from a document, the authentication-related information being related to authentication for the specific reading device to execute a process related to image reading from a document;
in a case where the authentication-related information is received from the specific reading device and the authentication-related information includes first type of information, display, on a display of the terminal device, a first input screen for prompting a user to input a user identifier and a password; and
in a case where the authentication-related information is received from the specific reading device and the authentication-related information includes second type of information different from the first type of information, display, on the display, a second input screen different from the first input screen for prompting a user to input only a password instead of a user identifier and the password.

2. The non-transitory computer-readable recording medium according to claim 1, wherein the computer program, when executed by the processor, further cause the terminal device to:
in a case where the computer program is activated, send, to the specific reading device, a sending request requesting the authentication-related information to be sent, wherein in response to the sending request being sent to the specific reading device, the authentication-related information is received from the specific reading device.

3. The non-transitory computer-readable recording medium according to claim 1, wherein the computer program, when executed by the processor, further cause the terminal device to:
display, on the display, a selection screen for selecting a reading device to be caused to execute the process from among a plurality of reading devices that are configured to communicate with the terminal device; and
in a case where an operation for selecting the specific reading device from among the plurality of reading devices is received on the selection screen, send, to the specific reading device, a sending request requesting the authentication-related information to be sent, wherein in response to the sending request being sent to the specific reading device, the authentication-related information is received from the specific reading device.

4. The non-transitory computer-readable recording medium according to claim 1, wherein the first type of information indicates that the specific reading device executes the authentication using a user identifier designated by a user and a password designated by the user.

5. The non-transitory computer-readable recording medium according to claim 1, wherein the second type of information indicates that the specific reading device executes the authentication using a fixed user identifier preset since dispatch of the specific reading device and a password designated by a user.

6. The non-transitory computer-readable recording medium according to claim 5, wherein the first input screen includes a first user identifier input area for inputting a user identifier and a first password input area for inputting a password, and
the second input screen includes a second user identifier input area in which the fixed user identifier is inputted and a second password input area for inputting a password.

7. The non-transitory computer-readable recording medium according to claim 6, wherein the second user identifier input area of the second input screen is configured so that characters in the second user identifier input area are non-changeable.

8. The non-transitory computer-readable recording medium according to claim 6, wherein the second type of information includes the fixed user identifier, and
the fixed user identifier included in the second type of information is inputted in the second user identifier input area.

9. The non-transitory computer-readable recording medium according to claim 6, wherein the second user identifier input area of the second input screen is configured so that characters in the second user identifier input area are changeable, and
the second input screen further includes a message for requesting not to change the fixed user identifier inputted in the second user identifier input area.

10. The non-transitory computer-readable recording medium according to claim 1, wherein the first input screen includes a first user identifier input area for inputting a user identifier and a first password input area for inputting a password, and
the second input screen includes a second password input area for inputting a password but does not include a user identifier input area for inputting a user identifier.

11. A terminal device comprising:
a display; and
a controller configured to:
receive authentication-related information from a specific reading device, a reading device being for image reading from a document, the authentication-related information being related to authentication for the specific reading device to execute a process related to image reading from a document;
in a case where the authentication-related information is received from the specific reading device and the authentication-related information includes first type of information, display, on the display, a first input screen for prompting a user to input a user identifier and a password; and
in a case where the authentication-related information is received from the specific reading device and the authentication-related information includes second type of information different from the first type of information, display, on the display, a second input screen different from the first input screen for prompting a user to input only a password instead of a user identifier and the password.

12. The terminal device according to claim 11, wherein the controller is further configured to:
in a case where a computer program of the terminal device is activated, send, to the specific reading device, a sending request requesting the authentication-related information to be sent,
wherein the controller is configured to, in response to the sending request being sent to the specific reading device, receive the authentication-related information from the specific reading device.

13. The terminal device according to claim 11, wherein the controller is further configured to:
display, on the display, a selection screen for selecting a reading device to be caused to execute the process from among a plurality of reading devices that are configured to communicate with the terminal device; and
in a case where an operation for selecting the specific reading device from among the plurality of reading devices is received on the selection screen, send, to the specific reading device, a sending request requesting the authentication-related information to be sent,
wherein the controller is configured to, in response to the sending request being sent to the specific reading device, receive the authentication-related information from the specific reading device.

14. The terminal device according to claim 11, wherein the first type of information indicates that the specific reading device executes the authentication using a user identifier designated by a user and a password designated by the user.

15. The terminal device according to claim 11, wherein the second type of information indicates that the specific reading device executes the authentication using a fixed user identifier preset since dispatch of the specific reading device and a password designated by a user.

16. A method for controlling a terminal device, the method comprising:
receiving authentication-related information from a specific reading device, a reading device being for image reading from a document, the authentication-related information being related to authentication for the specific reading device to execute a process related to image reading from a document;
in a case where the authentication-related information is received from the specific reading device and the authentication-related information includes first type of information, displaying, on a display of the terminal device, a first input screen for prompting a user to input a user identifier and a password; and
in a case where the authentication-related information is received from the specific reading device and the authentication-related information includes second type of information different from the first type of information, displaying, on the display, a second input screen different from the first input screen for prompting a user to input only a password instead of a user identifier and the password.

17. The method according to claim 16, further comprising:
in a case where a computer program of the terminal device is activated, sending, to the specific reading device, a sending request requesting the authentication-related information to be sent,
wherein in response to the sending request being sent to the specific reading device, the authentication-related information is received from the specific reading device.

18. The method according to claim 16, further comprising:
displaying, on the display, a selection screen for selecting a reading device to be caused to execute the process from among a plurality of reading devices that are configured to communicate with the terminal device; and
in a case where an operation for selecting the specific reading device from among the plurality of reading devices is received on the selection screen, sending, to the specific reading device, a sending request requesting the authentication-related information to be sent,
wherein in response to the sending request being sent to the specific reading device, the authentication-related information is received from the specific reading device.

19. The method according to claim 16, wherein the first type of information indicates that the specific reading device executes the authentication using a user identifier designated by a user and a password designated by the user.

20. The method according to claim 16, wherein the second type of information indicates that the specific reading device executes the authentication using a fixed user identifier preset since dispatch of the specific reading device and a password designated by a user.
